(19) United States
(12) Patent Application Publication
(10) Pub. No.: US 2006/0229417 A1
(43) Pub. Date: Oct. 12, 2006

(54) Polyphenylene sulfide- silicone vulcanizates

(76) Inventors: Frederic Ferrate, Barcelona (ES); Gifford Neale Shearer, Wadsworth, OH (US)

Correspondence Address: Dow Corning Corporation;CO1232, P.O. Box 994, 2200 W. Salzburg Road, Midland, MI, 48686-0994, US

(21) Appl. No.: 11/360,641

(22) Filed: Feb. 23, 2006

Related U.S. Application Data
(60) Provisional application No. 60/669,114, filed on Apr. 7, 2005.

(51) Int. Cl. C08L 83/04; C08L 81/00; B32B 27/00

(52) U.S. Cl. 525/474; 525/535

(57) ABSTRACT

A process is disclosed for preparing a thermoplastic elastomer containing polyphenylene sulfide and silicone elastomer by a dynamic vulcanization. The polyphenylene sulfide—silicone vulcanizates have improved temperature resistance properties.

### CROSS REFERENCE TO RELATED APPLICATIONS

None.

### TECHNICAL FIELD

This invention relates to a process for preparing a thermoplastic elastomer containing polyphenylene sulfide and silicone elastomer by a dynamic vulcanization. The present vulcanizates have improved temperature resistance properties.

### BACKGROUND

Thermoplastic elastomers can be obtained by uniformly mixing an elastomeric component with a thermoplastic resin. When the elastomeric component is also cross-linked during mixing, a thermoplastic elastomer known in the art as a thermoplastic vulcanizate (TPV) results.

Typically, a TPV is formed by a process known as dynamic vulcanization, wherein the elastomer and the thermoplastic matrix are mixed and the elastomer is cured with the aid of a crosslinking agent and/or catalyst during the mixing process. A number of such TPVs are known in the art, including some wherein the crosslinked elastomeric component can be a silicone polymer while the thermoplastic component is an organic, non-silicone polymer (i.e., a thermoplastic silicone vulcanizate or TPSiV). Representative examples of thermoplastic silicone vulcanizates (hereafter denoted as TPSiV) are disclosed in U.S. Pat. Nos. 6,362,287, 6,479,580, 6,649,704, and 6,759,487.

Polyphenylene sulfides provide an important class of thermoplastic resins used in the fabrication of many mechanical and/or electrical parts in a variety of applications, such as those common in the appliance and automotive industries. Polyphenylene sulfides are often used for their excellent thermal stability, insolubility, flame resistance, and chemical resistance properties. However, the inherent chemical and physical properties of polyphenylene sulfides also makes it difficult to combine this class of thermoplastic resins with elastomers to form TPVs. For example, TPVs containing silicone elastomers (rubber) are unknown.

The present inventors have discovered a process for preparing a polyphenylene sulfide based TPVs containing a silicone elastomer. The resulting compositions (TPSiV) retain most or all of the inherent properties of the PPS, but possess additional properties and benefits typically associated with silicones. A TPSiV based on PPS is expected to offer improved temperature resistance, i.e., both low temperature ductility as well as high temperature resistance, compared to conventional PPS. Also, the resulting TPSiV compositions have an improved feel, generally associated with silicone rubbers, vs the PPS alone.

### SUMMARY

This invention relates to a method for preparing a thermoplastic elastomer composition comprising:

(I) mixing
(A) a polyphenylene sulfide,
(B) an optional compatibilizer,
(C) an optional stabilizer,
(D) a silicone base comprising a curable organopolysiloxane,
(E) an optional crosslinking agent,
(F) a cure agent in an amount sufficient to cure said organopolysiloxane; and

(II) dynamically vulcanizing the organopolysiloxane,

wherein the weight ratio of polyphenylene sulfide to silicone base in the thermoplastic elastomer composition ranges from 90:10 to 10:90.

The invention also relates to the compositions produced from the present process and find utility in a variety of thermoplastic resin applications.

### DETAILED DESCRIPTION

(A) The Polyphenylene Sulfide

Component (A) in the present invention is a polyphenylene sulfide (designated as PPS). The polyphenylene sulfide can be any polymer considered or classified in the art as a poly(arylene sulfide). Structurally, such polymers have alternating aromatic rings and sulfur atoms. Typically, the aromatic rings are bonded to sulfur in the para position resulting in poly(p-phenylene sulfide). Typically, the PPS selected as component (A) is a thermoplastic resin having a melt point greater than 200° C. The physical form of the PPS is not critical, but typically is a powder or pellet. Representative, non-limiting examples of commercially available PPS products include those sold under the tradenames, RYTON® (Chevron Phillips Chemical Company, Houston, Tex.), TECHTRON® (Quadrant Engineering Plastic Products, Reading, Pa.) and FORTRON® (Ticona—North American Headquarters, Florence, Ky.).

The PPS may also contain other thermoplastic resins, for example as a blend or alloy mixture. However, the PPS useful as component (A) typically comprises at least 50 wt % of polyphenylene sulfide. Likewise, the PPS may be a copolymer or terpolymer, in which other monomers have been added during the polymerization to produce the PPS with altered chemical and physical properties. In such instances, at least 50 wt % of the PPS should comprise polyphenylene sulfide. Furthermore, the PPS may contain additional components or additives, such as fillers, pigments, glass or carbon fibers. Such additives may be added for any purpose, but in particular are added to alter resulting mechanical properties.

(B) The Optional Compatibilizer

Optional component (B) is a compatibilizer and may be selected from any hydrocarbon, organosiloxane, or combinations thereof that would be expected to enhance the mixing of the silicone base (D) with the PPS (A). Generally, the compatibilizer can be one of two types. In a first embodiment, herein referred to as a physical compatibilizer, the compatibilizer is selected from any hydrocarbon, organosiloxane, or combinations thereof, that would not be expected to react with the PPS (A), yet still enhance the mixing of the PPS with the silicone base. In a second embodiment herein referred to as a chemical compatibilizer, the compatibilizer is selected from any hydrocarbon, organosiloxane, or combinations thereof that could react chemically with the PPS. However in either embodiment, the compatibilizer must not prevent the dynamic vulcanization of the organopolysiloxane component, described infra.

In the physical compatibilizer embodiment, the compatibilizer (B) can be selected from any compatibilizer that would be expected to enhance the mixing of a silicone base with a PPS elastomer.

In the chemical compatibilizer embodiment, the compatibilizer (B) may be selected from (B′) organic (i.e., non-silicone) compounds which contain 2 or more olefin groups, (B″) organopolysiloxanes containing at least 2 alkenyl groups,(B′″) olefin-functional silanes which also contain at least one hydrolyzable group or at least one hydroxyl group attached to a silicon atom thereof, (B″″) an organopolysiloxane having at least one organofunctional groups selected from amine, amide, isocyanurate, phenol, acrylate, epoxy, and thiol groups, and any combinations of (B′), (B″), (B′″), and (B″″).

Organic compatibilizer (B′) can be illustrated by compounds such as diallyphthalate, triallyl isocyanurate, 2,4,6-triallyloxy-1,3,5-triazine, triallyl trimesate, 1,5-hexadiene, 1,7-octadiene, 2,2′-diallylbisphenol A, N,N′-diallyl tartardiamide, diallylurea, diallyl succinate and divinyl sulfone, inter alia.

Compatibilizer (B″) may be selected from linear, branched or cyclic organopolysiloxanes having at least 2 alkenyl groups in the molecule. Examples of such organopolysiloxanes include divinyltetramethyldisiloxane, cyclotrimethyltrivinyltrisiloxane, cyclo-tetramethyltetravinyltetrasiloxane, hydroxy end-blocked polymethylvinylsiloxane, hydroxy terminated polymethylvinylsiloxane-co-polydimethylsiloxane, dimethylvinylsiloxy terminated polydimethylsiloxane, tetrakis(dimethylvinylsiloxy)silane and tris(dimethylvinylsiloxy)phenylsilane. Alternatively, compatibilizer (B″) is a hydroxy terminated polymethylvinylsiloxane [HO(MeViSiO)ₓH] oligomer having a viscosity of about 25-100 m Pa-s, containing 25-35% vinyl groups and 2-4% silicon-bonded hydroxy groups.

Compatibilizer (B′″) is a silane which contains at least one alkylene group, typically comprising vinylic unsaturation, as well as at least one silicon-bonded moiety selected from hydrolyzable groups or a hydroxyl group. Suitable hydrolyzable groups include alkoxy, aryloxy, acyloxy or amido groups. Examples of such silanes are vinyltriethoxysilane, vinyltrimethoxysilane, hexenyltriethoxysilane, hexenyltrimethoxy, methylvinyldisilanol, octenyltriethoxysilane, vinyltriacetoxysilane, vinyltris(2-ethoxyethoxy)silane, methylvinylbis(N-methylacetamido)silane, methylvinyldisilanol.

Compatibilizer (B″″) is an organopolysiloxane having at least one organofunctional group selected from amine, amide, isocyanurate, phenol, acrylate, epoxy, and thiol groups.

The amount of compatibilizer used per 100 parts of PPS can be determined by routine experimentation. Typically, 0.05 to 20 parts by weight, or alternatively 0.05 to 15 parts by weight, or alternatively 0.1 to 5 parts of the compatibilizer is used for each 100 parts of PPS.

(C) The Optional Stabilizer

Component (C), a stabilizer may optionally be included in the composition. When used, stabilizer (C) is at least one organic compound selected from hindered phenols; thioesters; hindered amines; 2,2′-(1,4-phenylene)bis(4H-3,1-benzoxazin-4-one); or 3,5-di-tert-butyl-4-hydroxybenzoic acid, hexadecyl ester. Non-limiting specific examples of suitable hindered phenols include
1,1,3-Tris(2′-methyl-4′-hydroxy-5′-t-butylphenyl)butane, N,N′-hexamethylene bis(3-(3,5-di-t-butyl-4-hydroxyphenyl)propionamide), 4,4′-thiobis(2-t-butyl-5-methylphenol), 1,3,5-tris(4-tert-butyl-3-hydroxy-2,6-dimethyl benzyl)-1,3,5-triazine-2,4,6-(1H,3H,5H)-trione, N,N′-hexamethylenebis(3,5-di-tert-butyl-4-hydroxyhydrocinnamamide), tetrakis(methylene(3,5-di-tert-butyl-4-hydroxy-hydrocinnamate))methane, 1,3,5-trimethyl-2,4,6-tris(3,5-di-tert-butyl-4-hydroxybenzyl)benzene, 4,4′-methylenebis(2,6-di-tertiary-butylphenol), 2,2′-thiobis(6-tert-butyl-4-methylphenol), 2,2′-thiobis(4-octylphenol), 4,4′-thiobis(6-tert-butyl-2-methylphenol), 4,4′-thiobis(3,6-di-sec-amylphenol), 2-(4,6-bis(2,4-dimethylphenyl)-1,3,5,-triazin-2-yl)-5-(octyloxy)phenol, 2,4-bisoctylmercapto-6-(3,5-di-tert-butyl-4-hydroxyanilino)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate, 1,3,5-tris(4-tert-butyl-3-hydroxy-2,6-dimethylbenzyl)isocyanurate, 2,6-di-tert-butyl-4-methoxyphenol, 2,5-di-tert-butylhydroquinone, 2,5-di-tert-amylhydroquinone, 2,6-di-tert-butylhydroquinone, 2,5-di-tert-butyl-4-hydroxyanisole, 2,6-diphenyl-4-octadecyloxyphenol, 3,5-di-tert-butyl-4-hydroxyanisole, 3,5-di-tert-butyl-4-hydroxyphenyl stearate, bis(3,5-di-tert-butyl-4-hydroxyphenyl)adipate, esters of beta-(3,5-di-tert-butyl-4-hydroxyphenyl)propionic acid with mono- or polyhydric alcohols (e.g., methanol, ethanol, n-octanol, trimethylhexanediol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, trimethylolpropane, tris(hydroxyethyl)isocyanurate, N,N′-bis(hydroxyethyl)oxalamide, 3-thiaundecanol, 3-thiapentadecanol, 4-hydroxymethyl-1-phospha-2,6,7-trioxabicyclo(2.2.2)octane and esters of beta-(5-tert-butyl-4-hydroxy-3-methylphenyl)propionic acid with mono- or polyhydric alcohols (as above).

Specific non-limiting examples of suitable hindered amines include: 1,6-hexanediamine, N,N′-bis(2,2,6,6-pentamethyl-4-piperidinyl)-, polymers with morpholine-2,4,6-trichloro-1,3,5-triazine; 1,6-hexanediamine, N,N′-bis(2,2,6,6-tetramethyl-4-piperidinyl)-, polymers with 2,4,-Dichloro-6-(4-morpholinyl)-1,3,5-triazine; bis(1,2,2,6,6-pentamethyl-4-piperidinyl)sebacate; bis(2,2,6,6-tetramethyl-4-piperidinyl)sebacate; dimethyl succinate polymer with 4-hydroxy-2,2,6,6-tetramethyl-1-piperidine ethanol; and polymethyl(propyl-3-oxy-(2′,2′,6′,6′-tetramethyl-4′-piperidinyl)siloxane.

Non-limiting specific examples of component (C) include various hindered phenols marketed by Ciba Specialty Chemicals Corporation under the trade name Irganox™:
Irganox™ 1076=octadecyl 3,5-di-tert-butyl-4-hydroxyhydrocinnamate,
Irganox™ 1035=thiodiethylene bis(3,5-di-tert-butyl-4-hydroxyhydrocinnamate),
Irganox™ MD1024=1,2-bis(3,5-di-tert-butyl-4-hydroxyhydrocinnamoyl)hydrazine,
Irganox™ 1330=1,3,5-trimethyl-2,4,6-tris(3,5-di-tert-butyl-4-hydroxybenzyl)benzene,
Irganox™ 1425 WL=calcium bis(monoethyl(3,5-di-tert-butyl-4-hydroxybenzyl)phosphonate) and
Irganox™ 3114=1,3,5-tris-(3,5-di-tert-butyl-4-hydroxybenzyl)-1,3,5-triazine-2,4,6(1H,3H,5H)-trione. Alternatively, the hindered phenols are Irganox™ 245 {triethyleneglycol bis(3-(3′-tert-butyl-4′-hydroxy-5′-methylphenyl)propionate)}, Irganox™ 1098 {N,N′-hexamethylenebis(3,5-di-tert-butyl-4-hydroxyhydrocinnamamide)} and Irganox™ 1010 {tetrakis(methylene(3,5-di-tert-butyl-4-hydroxy-hydrocinnamate))methane}.

When included in the composition, 0.02 to 5 parts by weight of stabilizer (C) are employed for each 100 parts by weight of PPS (A) plus silicone base (D), alternatively from 0.1 to 0.75 parts by weight, or alternatively from 0.475 to 0.525 parts by weight, of (C) are added for each 100 parts by weight of (A) plus (D).

(D) The Silicone Base Comprising a Curable Organopolysiloxane

Component (D) is a silicone base comprising a curable organopolysiloxane (D′) and optionally, a filler (D″). A curable organopolysiloxane is defined herein as any organopolysiloxane having at least two curable groups present in its molecule. Organopolysiloxanes are well known in the art and are often designated as comprising any number of M units (R₃SiO_{0.5}), D units (R₂SiO), T units (RSiO_{1.5}), or Q units (SiO₂) where R is independently any monovalent hydrocarbon group. Alternatively, organopolysiloxanes are often described as having the following general formula; [RₘSi(O)_{4-m/2}]ₙ, where R is independently any monovalent hydrocarbon group and m=1-3, and n is at least two.

The organopolysiloxane in the silicone base (D) must have at least two curable groups in its molecule. As used herein, a curable group is defined as any organic group that is capable of reacting with itself or another organic group, or alternatively with a crosslinker to crosslink the organopolysiloxane. This crosslinking results in a cured organopolysiloxane. Representative of the types of curable organopolysiloxanes that can be used in the silicone base are the organopolysiloxanes that are known in the art to produce silicone rubbers upon curing. Representative, non-limiting examples of such organopolysiloxanes are disclosed in “Encyclopedia of Chemical Technology”, by Kirk-Othmer, 4^{th} Edition, Vol. 22, pages 82-142, John Wiley & Sons, NY which is hereby incorporated by reference. Typically, organopolysiloxanes can be cured via a number of crosslinking mechanisms employing a variety of cure groups on the organopolysiloxane, cure agents, and optional crosslinking agent. While there are numerous crosslinking mechanisms, three of the more common crosslinking mechanisms used in the art to prepare silicone rubbers from curable organopolysiloxanes are free radical initiated crosslinking, hydrosilylation or addition cure, and condensation cure. Thus, the curable organopolysiloxane can be selected from, although not limited to, any organopolysiloxane capable of undergoing anyone of these aforementioned crosslinking mechanisms. The selection of components (D), (E), and (F) are made consistent with the choice of cure or crosslinking mechanisms. For example if hydrosilylation or addition cure is selected, then a silicone base comprising an organopolysiloxane with at least two vinyl groups (curable groups) would be used as component (D′), an organohydrido silicon compound would be used as component (E), and a platinum catalyst would be used as component (F). For condensation cure, a silicone base comprising an organopolysiloxane having at least 2 silicon bonded hydroxy groups (ie silanol, considered as the curable groups) would be selected as component (D) and a condensation cure catalyst known in the art, such as a tin catalyst, would be selected as component (F). For free radical initiated crosslinking, any organopolysiloxane can be selected as component (D), and a free radical initiator would be selected as component (F) if the combination will cure within the time and temperature constraints of the dynamic vulcanization step (II). Depending on the selection of component (F) in such free radical initiated crosslinking, any alkyl group, such as methyl, can be considered as the curable groups, since they would crosslink under such free radical initiated conditions.

The quantity of the silicone phase, as defined herein as the combination of components (D), (E) and (F), used can vary depending on the amount of PPS (A) used. However, it is typical to use levels of PPS (A) of 10 to 90 wt. %, alternatively, 50 to 90 wt. %, or alternatively 60 to 80 wt. % based on the total weight of components (A) through (F).

It is also convenient to report the weight ratio of PPS (A) to the silicone base (D) which typically ranges from 90:10 to 10:90, alternatively 90:10 to 40:60, alternatively 80:20 to 40:60.

In the addition cure embodiment of the present invention, the selection of components (D), (E), and (F) can be made to produce a silicon rubber during the vulcanization process via hydrosilylation cure techniques. This embodiment is herein referred to as the hydrosilylation cure embodiment. Thus, in the hydrosilylation cure embodiment, (D′) is selected from a diorganopolysiloxane gum which contains at least 2 alkenyl groups having 2 to 20 carbon atoms in its molecule and optionally (D″), a reinforcing filler. The alkenyl group on the gum is specifically exemplified by vinyl, allyl, butenyl, pentenyl, hexenyl and decenyl, preferably vinyl or hexenyl. The position of the alkenyl functionality is not critical and it may be bonded at the molecular chain terminals, in non-terminal positions on the molecular chain or at both positions. Typically, the alkenyl group is vinyl or hexenyl and that this group is present at a level of 0.0001 to 3 mole percent, alternatively 0.0005 to 1 mole percent, in the diorganopolysiloxane. The remaining (i.e., non-alkenyl) silicon-bonded organic groups of the diorganopolysiloxane are independently selected from hydrocarbon or halogenated hydrocarbon groups which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. It will be understood, or course, that these groups are selected such that the diorganopolysiloxane has a glass temperature (or melt point) which is below room temperature and the cured polymer is therefore elastomeric. Typically, the non-alkenyl silicon-bonded organic groups in the diorganopolysiloxane makes up at least 85, or alternatively at least 90 mole percent, of the organic groups in the diorganopolysiloxanes.

Thus, polydiorganosiloxane (D′) can be a homopolymer, a copolymer or a terpolymer containing such organic groups. Examples include copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others. The molecular structure is also not critical and is exemplified by straight-chain and partially branched straight-chain structures, the linear systems being the most typical.

Specific illustrations of diorganopolysiloxane (D′) include: trimethylsiloxy-endblocked dimethylsiloxane-methylvinylsiloxane copolymers; trimethylsiloxy-endblocked methylphenylsiloxane-dimethylsiloxane-methylvinylsiloxane copolymers; trimethylsiloxy-endblocked 3,3,3-trifluoropropylmethyl siloxane copolymers; trimethylsiloxy-endblocked 3,3,3-trifluoropropylmethyl-methylvinylsiloxane copolymers; dimethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers; and similar copolymers wherein at least one end group is dimethylhydroxysiloxy. Typical systems for low temperature applications include methylphenylsiloxane-dimethylsiloxane-methylvinylsiloxane copolymers and diphenylsiloxane-dimethylsiloxane-methylvinylsiloxane copolymers, particularly wherein the molar content of the dimethylsiloxane units is about 85-95%.

The gum may also consist of combinations of two or more organopolysiloxanes. Alternatively, diorganopolysiloxane (D′) is a linear polydimethylsiloxane homopolymer and is preferably terminated with a vinyl group at each end of its molecule or it is such a homopolymer, which also contains at least one vinyl group along its main chain.

For the purposes of the present invention, the molecular weight of the diorganopolysiloxane gum is sufficient to impart a Williams plasticity number of at least about 30 as determined by the American Society for Testing and Materials (ASTM) test method D 926. Although there is no absolute upper limit on the plasticity of component (D′), practical considerations of processability in conventional mixing equipment generally restrict this value. Typically, the plasticity number should be 40 to 200, or alternatively 50 to 150.

Methods for preparing high consistency unsaturated group-containing diorganopolysiloxanes are well known and they do not require a detailed discussion in this specification.

Optional component (D″) is any filler which is known to reinforce diorganopolysiloxane (D′) and is preferably selected from finely divided, heat stable minerals such as fumed and precipitated forms of silica, silica aerogels and titanium dioxide having a specific surface area of at least about 50 m²/gram. The fumed form of silica is a typical reinforcing filler based on its high surface area, which can be up to 450 m²/gram. Alternatively, a fumed silica having a surface area of 50 to 400 m²/g, or alternatively 90 to 380 m²/g, can be used. The filler is added at a level of about 5 to about 150 parts by weight, alternatively 10 to 100 or alternatively 15 to 70 parts by weight, for each 100 parts by weight of diorganopolysiloxane (D′).

The filler is typically treated to render its surface hydrophobic, as typically practiced in the silicone rubber art. This can be accomplished by reacting the silica with a liquid organosilicon compound which contains silanol groups or hydrolyzable precursors of silanol groups. Compounds that can be used as filler treating agents, also referred to as anti-creping agents or plasticizers in the silicone rubber art, include such ingredients as low molecular weight liquid hydroxy- or alkoxy-terminated polydiorganosiloxanes, hexaorganodisiloxanes, cyclodimethylsilazanes and hexaorganodisilazanes.

Component (D) may also contain other materials commonly used in silicone rubber formulations including, but not limited to, antioxidants, crosslinking auxiliaries, processing agents, pigments, and other additives known in the art, which do not interfere with step (II) described infra.

In the hydrosilylation cure embodiment of the present invention, compound (E) is added and is an organohydrido silicon compound (E′), that crosslinks with the diorganopolysiloxane (D′). The organohydrido silicon compound is an organopolysiloxane which contains at least 2 silicon-bonded hydrogen atoms in each molecule which are reacted with the alkenyl functionality of (D′) during the dynamic curing step (II) of the present method. A further (molecular weight) limitation is that Component (E′) must have at least about 0.2 weigh percent hydrogen, alternatively 0.2 to 2 or alternatively 0.5 to 1.7, percent hydrogen bonded to silicon. Those skilled in the art will, of course, appreciate that either the diorganopolysiloxane (D′) or component (E′), or both, must have a functionality greater than 2 to cure the diorganopolysiloxane (i.e., the sum of these functionalities must be greater than 4 on average). The position of the silicon-bonded hydrogen in component (E′) is not critical, and it may be bonded at the molecular chain terminals, in non-terminal positions along the molecular chain or at both positions. The silicon-bonded organic groups of component (E′) are independently selected from any of the saturated hydrocarbon or halogenated hydrocarbon groups described above in connection with diorganopolysiloxane (D′), including preferred embodiments thereof. The molecular structure of component (E′) is also not critical and is exemplified by straight-chain, partially branched straight-chain, branched, cyclic and network structures, linear polymers or copolymers being typical. It will, of course, be recognized that this component must be compatible with D′ (i.e., it is effective in curing the diorganopolysiloxane).

Component (E′) is exemplified by the following: low molecular weight siloxanes such as PhSi(OSiMe₂H)₃; trimethylsiloxy-endblocked methylhydridopolysiloxanes; trimethylsiloxy-endblocked dimethylsiloxane-methylhydridosiloxane copolymers; dimethylhydridosiloxy-endblocked dimethylpolysiloxanes; dimethylhydrogensiloxy-endblocked methylhydrogenpolysiloxanes; dimethylhydridosiloxy-endblocked dimethylsiloxane-methylhydridosiloxane copolymers; cyclic methylhydrogenpolysiloxanes; cyclic dimethylsiloxane-methylhydridosiloxane copolymers; tetrakis(dimethylhydrogensiloxy)silane; silicone resins composed of (CH₃)₂HSiO_{1/2}, (CH₃)₃SiO_{1/2}, and SiO_{4/2} units; and silicone resins composed of (CH₃)₂HSiO_{1/2}, (CH₃)₃SiO_{1/2}, CH₃SiO_{3/2}, PhSiO_{3/2} and SiO_{4/2} units, wherein Ph hereinafter denotes phenyl radical.

Typical organohydrido silicon compounds are polymers or copolymers comprising RHSiO units terminated with either R₃SiO_{1/2} or HR₂SiO_{1/2} units wherein R is independently selected from alkyl radicals having 1 to 20 carbon atoms, phenyl or trifluoropropyl, typically methyl. Also, typically the viscosity of component (E′) is about 0.5 to 1,000 mPa-s at 25° C., alternatively 2 to 500 mPa-s. Component (E′) typically has 0.5 to 1.7 weight percent hydrogen bonded to silicon. Alternatively, component (E′) is selected from a polymer consisting essentially of methylhydridosiloxane units or a copolymer consisting essentially of dimethylsiloxane units and methylhydridosiloxane units, having 0.5 to 1.7 weight percent hydrogen bonded to silicon and having a viscosity of 2 to 500 mPa-s at 25° C. Such a typical system has terminal groups selected from trimethylsiloxy or dimethylhydridosiloxy groups. Component (E′) may also be a combination of two or more of the above described systems.

The organohydrido silicon compound (E′) is used at a level sufficient to cure diorganopolysiloxane (D′) in the presence of component (F), described infra. Typically, its content is adjusted such that the molar ratio of SiH therein to Si-alkenyl in (D′) is greater than 1. Typically, this SiH/alkenyl ratio is below about 50, alternatively 1 to 20 or alternatively 1 to 12. These SiH-functional materials are well known in the art and many are commercially available.

In the hydrosilylation cure embodiment of the present invention, component (F) is a hydrosilation catalyst (F′), that accelerates the cure of the diorganopolysiloxane. It is exemplified by platinum catalysts, such as platinum black, platinum supported on silica, platinum supported on carbon, chloroplatinic acid, alcohol solutions of chloroplatinic acid, platinum/olefin complexes, platinum/alkenylsiloxane complexes, platinum/beta-diketone complexes, platinum/phosphine complexes and the like; rhodium catalysts, such as rhodium chloride and rhodium chloride/di(n-butyl)sulfide complex and the like; and palladium catalysts, such as palladium on carbon, palladium chloride and the like. Component (F′) is typically a platinum-based catalyst such as chloroplatinic acid; platinum dichloride; platinum tetrachloride; a platinum complex catalyst produced by reacting chloroplatinic acid and divinyltetramethyldisiloxane which is diluted with dimethylvinylsiloxy endblocked polydimethylsiloxane, prepared according to U.S. Pat. No. 3,419,593 to Willing; and a neutralized complex of platinous chloride and divinyltetramethyldisiloxane, prepared according to U.S. Pat. No. 5,175,325 to Brown et al. , these patents being hereby incorporated by reference. Alternatively, catalyst (F) is a neutralized complex of platinous chloride and divinyltetramethyldisiloxane.

Component (F′) is added to the present composition in a catalytic quantity sufficient to promote the reaction between organopolysiloxane (D′) and component (E′) so as to cure the organopolysiloxane within the time and temperature limitations of the dynamic vulcanization step (II). Typically, the hydrosilylation catalyst is added so as to provide about 0.1 to 500 parts per million (ppm) of metal atoms based on the total weight of the elastomeric base composition, alternatively 0.25 to 50 ppm.

In another embodiment, components (D), (E), and (F) are selected to provide a condensation cure of the organopolysiloxane. For condensation cure, an organopolysiloxane having at least 2 silicon bonded hydroxy groups (i.e. silanol, considered as the curable groups) would be selected as component (D), a organohydrido silicon compound would be selected as the optional crosslinking agent (E), and a condensation cure catalyst known in the art, such as a tin catalyst, would be selected as component (F). The organopolysiloxanes useful as condensation curable organopolysiloxanes is any organopolysiloxane which contains at least 2 silicon bonded hydroxy groups (or silanol groups) in its molecule. Typically, any of the organopolysiloxanes described infra as component (D) in the addition cure embodiment, can be used as the organopolysiloxane in the condensation cure embodiment, although the alkenyl group would not be necessary in the condensation cure embodiment. The organohydrido silicon compound useful as the optional crosslinking agent (E) is the same as described infra for component (E). The condensation catalyst useful as the curing agent in this embodiment is any compound which will promote the condensation reaction between the SiOH groups of diorganopolysiloxane (D) and the SiH groups of organohydrido silicon compound (E) so as to cure the former by the formation of —Si—O—Si— bonds. Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide (see, e.g., U.S. Pat. No. 3,024,210).

In yet another embodiment, components (D), (E), and (F) can be selected to provide a free radical cure of the organopolysiloxane. In this embodiment, the organopolysiloxane can be any organopolysiloxane but typically, the organopolysiloxane has at least 2 alkenyl groups. Thus, any of the organopolysiloxane described supra as suitable choices for (D′) in the addition cure embodiment can also be used in the free radical embodiment of the present invention. A crosslinking agent (E) is not required in the free radical cure embodiment. The cure agent (F) can be selected from any of the free radical initiators described supra for the selection of component (B).

In addition to the above-mentioned major components (A) through (F), a minor amount (i.e., less than 50 weight percent of the total composition) of one or more optional additive (G) can be incorporated in the compositions of the present invention. These optional additives can be illustrated by the following non-limiting examples: extending fillers such as quartz, calcium carbonate, and diatomaceous earth; pigments such as iron oxide and titanium oxide; fillers such as carbon black and finely divided metals; heat stabilizers such as hydrated cerric oxide, calcium hydroxide, magnesium oxide; and flame retardants such as halogenated hydrocarbons, alumina trihydrate, magnesium hydroxide, wollastonite, organophosphorous compounds and other fire retardant (FR) materials, handling additives, and other additives known in the art.

Mixing for step (I) can be performed in any mixing device that is capable of uniformly and quickly dispersing the components (B) through (G) with PPS (A). Typically the mixing occurs by an extrusion process such as a twin-screw extruder. The order of mixing components (A) through (E) is not critical. Typically (G) would be added after addition of the other components, but it is not critical as long as (G) does not interfere with cure of the organopolysiloxane. Typically, the extrusion mixing process is conducted at a temperature range of 100 to 350° C., alternatively, 125 to 300° C., and yet alternatively 150 to 250° C.

The second step (II) of the method of the present invention is dynamically vulcanizing the organopolysiloxane. The dynamic vulcanizing step cures the organopolysiloxane. Step (II) can occur simultaneous with the mixing step (I), or alternatively following the mixing step (I). Typically, step (II) occurs simultaneous with the mixing step (I), and is effected by the same temperature ranges and mixing procedures described for step (I).

The present invention also relates to the thermoplastic elastomeric compositions prepared according to the methods taught herein. The PPS-silicone compositions prepared by the methods of the present invention can be processed in a similar manner as conventional PPS materials, that is they may be extruded, blow molded, or compression molded into blocks, rods, or other shaped products. The PPS-silicone thermoplastic compositions, or PPS TPSiVs find utility in many of the conventional PPS applications, and in particular in those application requiring improved low temperature ductility or high temperature resistance. Represenative non limiting commericial utilities for the PPS TPSiV compositions are: automotive applications such as powertrain components, sensors, pumps, and fuel rails; electrical/electronic components; surface mount connectors and chip carriers; industrial/mechanical applications such as blower and pump parts, impellers, and flowmeters; consumer/appliance equipment such as electrical heater grills, hot comb components, powertool parts, and insulators.

1. A method for preparing a thermoplastic elastomer composition comprising:
(I) mixing
(A) a polyphenylene sulfide,
(B) an optional compatibilizer,
(C) an optional stabilizer,
(D) a silicone base comprising a curable organopolysiloxane,
(E) an optional crosslinking agent,
(F) a cure agent in an amount sufficient to cure said organopolysiloxane; and
(II) dynamically vulcanizing the organopolysiloxane,
wherein the weight ratio of polyphenylene sulfide to silicone base in the thermoplastic elastomer composition ranges from 90:10 to 10:90.

2. A thermoplastic elastomer composition prepared according to the method of claim 1.

3. An article of manufacture comprising the thermoplastic composition of claim 2.
